(19) United States
(12) Patent Application Publication
(10) Pub. No.: US 2012/0103145 A1
(43) Pub. Date: May 3, 2012

(54) MASTER LINK CLIP REMOVAL TOOL

(76) Inventor: GLENN HIXSON, Denison, TX (US)

(21) Appl. No.: 12/938,818

(22) Filed: Nov. 3, 2010

(51) Int. Cl. B25B 7/02; B23P 11/00

(52) U.S. Cl. 81/418; 29/426.1

(57) ABSTRACT

A master link tool comprising a pair of jaw members stretching laterally, a set of handle grips extending from the pair of jaw members, where the set of handle grips enable a user to manipulate the pair of jaw members, a pivot rivet attached between the pair of jaw members and the set of handle grips, to enable the set of handle grips to move the pair of jaw members, a pair of tips attached to a distal end of the pair of jaw member, and a set of inward projections fastened to the pair of tips wherein the set of inward projections engage a master link clip within a master link to permit a user to squeeze the set of handle grips thus tightening the pair of jaw members in order to dislodge the master link from a roller chain.

### BACKGROUND OF THE INVENTION

1. Field of the Invention

The present invention relates to a hand tool to better enable a user to remove a master link from a roller chain.

2. Description of Related Art

A common problem experienced by people who work with bicycles or motorcycles is that when they need to replace or repair the roller chain. They often experience difficulties and potential injury when removing the roller chain. The ends of the roller chain are connected by a master link which utilizes a master link clip to lock the ends against the master link. For removal, the master link clip must be loosened or removed to disengage the master link from the ends. Most people experience problems when trying to manipulate the master link clip. Some individuals may utilize a pocket knife, a pair of needle nose pliers, a set of side cutters or even their fingernails. All of these tools and instruments may eventually remove the master link clip, but at a cost. The tool, master link, roller chain and even the individual may all be damaged after use, creating more problems to attend to after chain removal.

Some inventions have been made to assist a user when removing a master link. U.S. Pat. No. 3,937,005 to Becker discloses A Key for Removing Locking Members from Drive Chains or the like where an L-shaped tool is used to engage and release the locking member (or master link) from a drive chain. The key is useful to remove the locking member, but it does not enable delicate manipulation. The key merely dislodges or pops out the locking member without enabling precise manipulations of the locking member or the chain. As an improvement, U.S. Pat. No. 5,193,336 to King discloses a Tool and Method for Removing a Clip Member from a Master Link in a Chain Member wherein a tool, similar to a pair of slide adjustable pliers, with a set of recesses modified at the tips to engage the master link for removal. This tool does provide more precise movement and manipulation capabilities but the opening for the adjustment bolt may eventually become problematic for the user. The bolt may slide within the opening at unwanted times potentially causing damage to the master link, chain or user.

It would be desirable in the art to provide a tool that enables the user to precisely manipulate a master link without causing damage to the master link, chain or user. It would also be beneficial to provide a tool that is multifunctional.

### SUMMARY OF THE INVENTION

An object of the present invention is to provide a hand tool, similar to a set of needle nose pliers, which enables a user to remove a master link from a roller chain by providing a set of inward projections affixed to the jaw tips. The set of inward projections enable precise manipulation of the master link for removal to prevent injury or damage to the user and tools.

Another object of the primary invention is to provide a hand tool which not only removes a master link but also functions as a pair of pliers.

In view of the foregoing disadvantages inherent in the prior art, the present invention provides a master link tool comprising a pair of jaw members stretching laterally, a set of handle grips extending from the pair of jaw members, where the set of handle grips enable a user to manipulate the pair of jaw members, a pivot rivet attached between the pair of jaw members and the set of handle grips, to enable the set of handle grips to move the pair of jaw members, a pair of tips attached to a distal end of the pair of jaw member, and a set of inward projections fastened to the pair of tips wherein the set of inward projections engage a master link clip within a master link to permit a user to squeeze the set of handle grips thus tightening the pair of jaw members in order to dislodge the master link from a roller chain.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a master link tool in accordance with an exemplary embodiment of the present invention; and

FIG. 1A depicts an enlarged view of a master link in accordance with an exemplary embodiment of the present invention.

Like reference numerals refer to like parts throughout the description of several views of the drawings.

### DETAILED DESCRIPTION OF THE DRAWINGS

The present invention relates to a hand tool to better enable a user to remove a master link from a roller chain wherein the hand tool, similar to a set of pliers, includes a set of inward projections fastened to the tip to engage a master link clip and dislodge the clip from the master link, thus separating the master link from the roller chain. The present invention discloses a master link tool to safely dislodge master link clips without causing bodily damage to the user, damage to the clip or roller chain. The master link tool is a manually operated device that allows a user to replace master links in a more efficient manner. Also, the master link tool functions to not only remove master links but also to serve as a set of pliers thus providing a multifunctional tool.

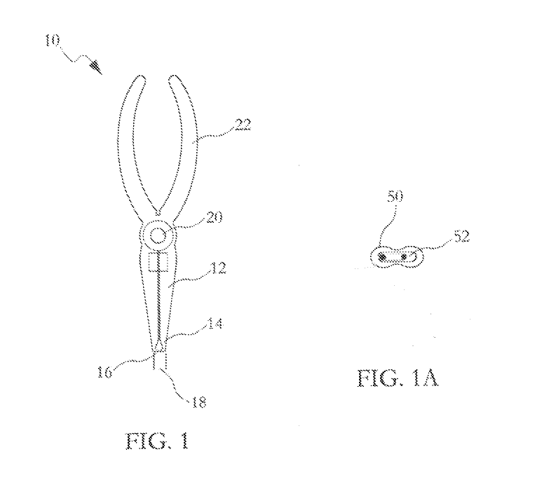

Turning now descriptively to the drawings, referring to FIG. 1, a perspective view of a master link tool (10) is shown in accordance with an exemplary embodiment of the present invention. The master link tool (10) may comprise a pair of jaw members (12) extending laterally against each other from a pivot rivet (20) and a pair of tips (14) at a distal end. A set of handle grips (22) may be joined to the pair of jaw members (12) at the pivot rivet (20). The pair of jaw members (12) may be manipulated by a set of handle grips (22) when the set of handle grips (22) are moved towards and away from each other. The master link tool (10) may function and resemble a set of pliers, specifically a pair of needle nose pliers, but with useful improvements and modifications. The pair of jaw members (12) press against each other along their entire length to create a tight and secure grip, wherein the tighter the set of handle grips (22) are squeezed the tighter the grip between the pair of jaw members (12). When the set of handle grips (22) are apart and the pair of jaw members (12) separate the master link tool (10) moves to an open position. When the set of handle grips (22) are squeezed together and the pair of jaw members (12) are joined the master link tool (10) moves to a closed position.

The pair of jaw members (12) may be made from a hardened steel or similar material for durability and strength. Accordingly, the set of handle grips (22) may be made from the same steel or similar material as the pair of jaw members (12). Also, the set of handle grips (22) may be covered with a plastic, rubber similar material to provide a user with a more comfortable grip when using the master link tool (10). Along the length of the pair of jaw members (12), on the surfaces touching each other, may a set of gripping teeth to engage an item for use, like the pair of pliers. Therefore, the master link tool (10) may be used for multiple purposes; to remove a master link and as a set of needle nose pliers.

At the distal end of the pair of jaw members (12) is the pair of tips (14). The pair of tips (14) may include a distance between them when the pair of jaw members (12) are in the closed position. At the very end of the pair of tips (14) may be a set of inward projections (16). The set of inward projections (16) meet at a central point in the middle of the distance between the pair of tips (14). The length of the set of inward projections (16) and the distance between the pair of tips (14) may be a tip separation (18). The tip separation (18) may be a measured distance designed to for use with a specific tool or item. The tip separation (18) may be around a ¼ inch to enable precise and accurate manipulation of the inward projections (16).

Accordingly, referring to FIG. 1A an enlarged view of a master link (50) is shown in accordance with an exemplary embodiment of the present invention. The master link (50) may include a master link clip (52) which fits tight and securely against the master link (50). The master link (50) joins a set of ends of a roller chain together which may be used for a bicycle, motorcycle or the like. The master link tool (10) is specifically designed so that the pair of tips (14) fit against the master link clip (52), for master link (50) removal. The master link tool (10) may be used with a variety of sizes of master links (50) so that one tool is useful for a variety of items.

For use, first the master link tool (10) is in the open position to wrap the pair of tips around the master link (50). Next, the set of inward projections (16) may engage the master link clip (52) by squeezing the set of handle grips (220) to dislodge the master link clip (52) from the master link (50). Third, the user may twist the master link tool (10) while the set of inward projections (16) are engaged around the master link clip (52) to release the master link clip (52) from the master link (50). Finally, the master link (50) may be removed from the roller chain to separate the set of ends and enable the user to do repairs or make replacements. The master link tool (10) may provide the user with a tool to easily dislodge or remove the master link (50) without causing damage to the roller chain, master link or the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A master link tool for removing a master chain link comprising:
a pair of jaw members stretching laterally, where said pair of jaw members rest next to each other when engaged;
a set of handle grips extending from said pair of jaw members, where said set of handle grips enable a user to manipulate said pair of jaw members;
a pivot rivet attached between said pair of jaw members and said set of handle grips, where said pivot rivet enables said set of handle grips to move said pair of jaw members;
a pair of tips attached to a distal end of said pair of jaw members; and
a set of inward projections fastened to said pair of tips wherein said set of inward projections engage a master link clip within a master link to permit a user to squeeze said set of handle grips thus tightening said pair of jaw members in order to dislodge said master link from a roller chain.

2. The master link tool of claim 1, wherein said set of handle grips move said pair of jaw members between a closed position, wherein said pair of jaw members are joined, and an open position, wherein said pair of jaw members are separated.

3. The master link tool of claim 1, wherein said pair of jaw members are made from a hardened steel material.

4. The master link tool of claim 1, wherein said set of handle grips are covered in a rubber material to provide a better grip for said user.

5. A method of using a master link tool comprising the steps of:
opening a pair of tips attached to a pair of jaw members to place around a master link;
engaging a master link clip against said master link with a set of inward projections affixed to said pair of tips;
squeezing a set of handle grips attached to said pair of jaw members to tighten said inward projections around said master link clip; and
twisting said set of handle grips to turn said set of inward projections to release said master link clip from said master link.

6. The method of use for said master link tool further comprising the step of separating said master link from a roller chain.
